(19) United States
(12) Patent Application Publication
(10) Pub. No.: US 2009/0094895 A1
(43) Pub. Date: Apr. 16, 2009

(54) STOPPER STRUCTURE OF WINDOW REGULATOR FOR VEHICLE

(76) Inventor: Hoosang Park, Gyeonggi-do (KR)

Correspondence Address: MORGAN, LEWIS & BOCKIUS LLP (SF), One Market, Spear Street Tower, Suite 2800, San Francisco, CA, 94105, US

(21) Appl. No.: 11/956,092

(22) Filed: Dec. 13, 2007

(30) Foreign Application Priority Data
Oct. 16, 2007 (KR) 10-2007-0104140

(51) Int. Cl. E05F 15/02

(52) U.S. Cl. 49/28

(57) ABSTRACT

A stopper structure of a window pane includes a pane holder attached to a lower portion of the window pane a guide rail along which the pane holder is movable, and a stopper block attached to the guide rail. The stopper block is configured to interfere with the pane holder to limit a range of motion of the pane holder along the guide rail. The stopper block may include a main part and a protrusion, protruding from the main part. The protrusion may be riveted into a hole in the guide rail, and the main part may interfere with the pane holder.

### CROSS-REFERENCE TO RELATED APPLICATIONS

The present application is based on, and claims priority from, Korean Application Serial Number 10-2007-0104140, filed on Oct. 16, 2007, the disclosure of which is hereby incorporated by reference herein in its entirety.

### FIELD OF THE INVENTION

The present invention relates to a stopper structure of a window regulator that limits the movement of a window pane provided in a frameless vehicle door.

### BACKGROUND OF THE INVENTION

Many vehicle windows are supported by frames. However, some, such as those in convertibles, are provided in frameless doors. These require separate stopper structures.

A typical stopper structure includes a stabilizer mounted on a vehicle inner panel, and a catch mounted on the window pane. The stabilizer stops the catch, restricting the window from moving past a certain point. This structure is complicated, and difficult to manufacture.

The above information disclosed in this Background section is only for enhancement of understanding of the background of the invention and therefore it may contain information that does not form the prior art that is already known in this country to a person of ordinary skill in the art.

### SUMMARY OF THE INVENTION

A stopper structure of a window pane includes a pane holder attached to a lower portion of the window pane, a guide rail along which the pane holder is movable, and a stopper block attached to the guide rail. The stopper block is configured to interfere with the pane holder to limit a range of motion of the pane holder along the guide rail.

The stopper block may include a main part and a protrusions protruding from the main part. The protrusion may be riveted into a hole in the guide rail, and the main part may interfere with the pane holder.

### BRIEF DESCRIPTION OF THE DRAWINGS

For a better understanding of the nature and objects of the present invention, reference should be made to the following detailed description with the accompanying drawings, in which:

FIG. 1 illustrates a stopper structure of a window regulator for a vehicle according to an embodiment of the present invention;

FIG. 2 shows a guide rail and a stopper block of the structure of FIG. 1;

FIG. 3 is a cross-sectional view taken along line III-III of FIG. 2;

FIG. 4 is a perspective view of the stopper block of FIG. 2; and

FIG. 5 illustrates operation of the structure of FIG. 1.

### DETAILED DESCRIPTION OF THE PREFERRED EMBODIMENTS

A preferred embodiment of the present invention will be described hereinafter with reference to the accompanying drawings.

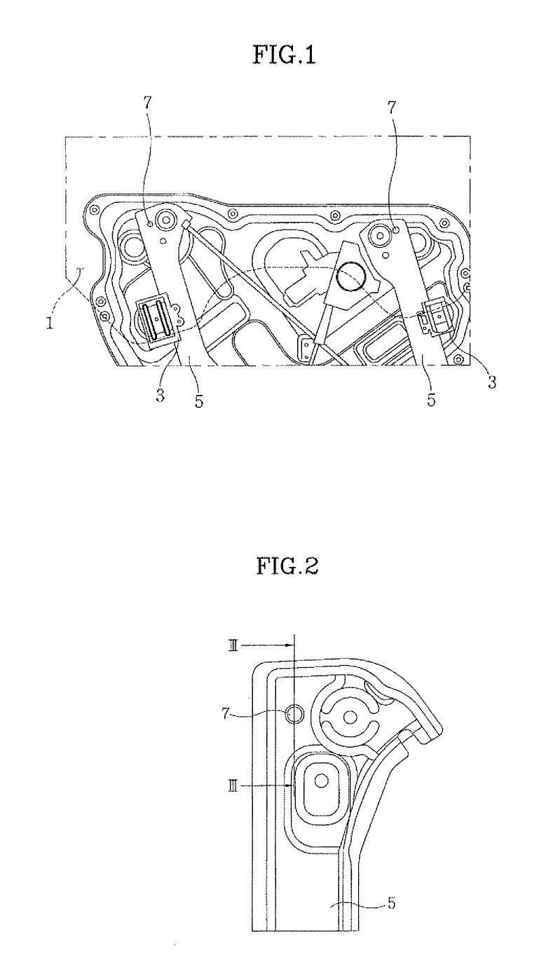

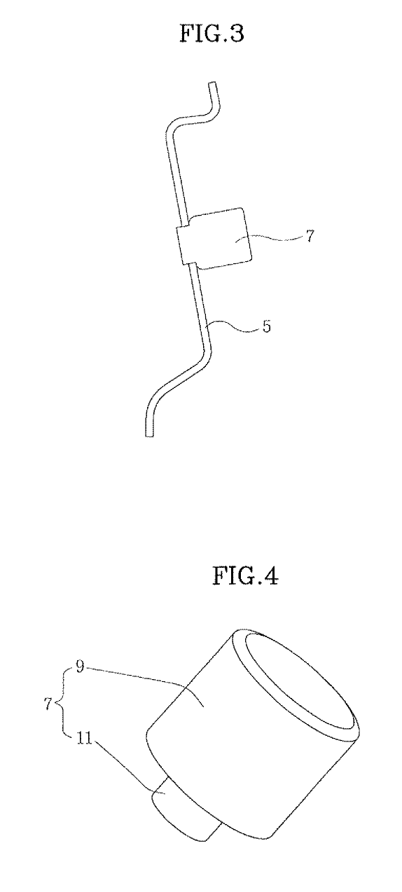

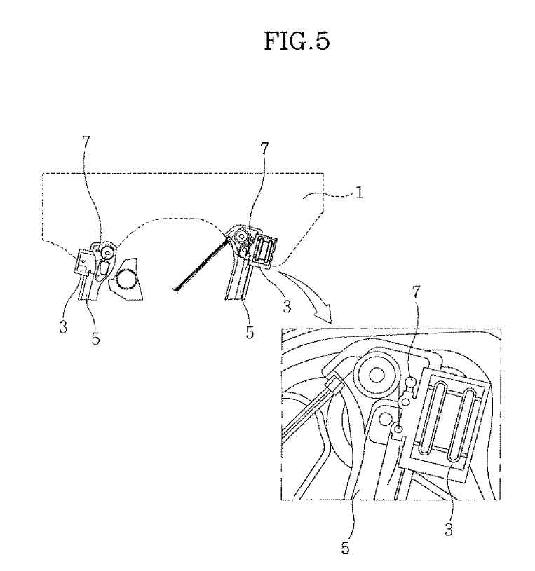

The structure illustrated in FIG. 1 may be provided inside a vehicle door. Window pane 1 is movable between the lower, open position shown in FIG. 1, and the upper, closed position shown in FIG. 5.

A stopper structure of a window regulator for a vehicle according to an embodiment of the present invention includes glass holders 3, guide rails 5, and stopper blocks 7. A lower portion of a window pane 1 is fixed to glass holders 3. Guide rails 5 guide upward and downward movement of glass holders 3. Stopper blocks 7 are fixed to guide rails 5, and interfere with glass holders 3 to limit the range of motion of the glass holders 3 to limit the range of motion of window pane 1.

A hole may be provided through guide rail 5, and stopper block 7 may be riveted into the fixing hole.

Each of stopper blocks 7 includes a cylindrical block pan 9, and a protrusion 11 with a diameter smaller than the diameter of block part 9 which is riveted into the hole.

One stopper block 7 may be provided at each of front and rear guide rails 5.

When window pane 1 reaches the upper limit position as shown in FIG. 5, glass holders 3 are caught by stopper blocks 7, stopping the window pane 1 form lifting any higher.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stopper structure of a window pane, comprising:
a pane holder attached to a lower portion of the window pane;
a guide rail along which the pane holder is movable; and
a stopper block attached to the guide rail, configured to interfere with the pane holder to limit a range of motion of the pane holder along the guide rail.

2. The stopper structure as defined in claim 1, wherein the stopper block is riveted into a hole in the guide rail.

3. The stopper structure as defined in claim 2, wherein the stopper block comprises a main part and a protrusion, protruding from the main part; wherein the protrusion is riveted into the hole, and the main part is configured to interfere with the pane holder.

4. A stopper structure of a window pane, comprising:
two pane holders attached to opposite sides of a lower portion of the window pane;
two guide rails, along each of which one of the pane holders is movable; and
a stopper block attached to each guide rail, configured to interfere with the pane holder to limit a range of motion of the pane holder along the guide rail.
